(19) United States
(12) Patent Application Publication
(10) Pub. No.: US 2020/0230662 A1
(43) Pub. Date: Jul. 23, 2020

(54) METHODS OF CLEANING MUSICAL WIND INSTRUMENTS

(71) Applicant: UniVr Music SAS, St. Martin d'Uriage (FR)

(72) Inventors: Jean Pierre Acquadro, Brie et Angonnes (FR); Benoit Bertet, Gieres (FR); Vincent Charlon, Saint Martin d'Uriage (FR)

(21) Appl. No.: 16/750,393

(22) Filed: Jan. 23, 2020

Related U.S. Application Data
(60) Provisional application No. 62/795,830, filed on Jan. 23, 2019.

(51) Int. Cl. B08B 7/00; G10G 7/00; B08B 5/00; B08B 9/027

(52) U.S. Cl. CPC B08B 7/0057; G10G 7/00; B08B 2209/027; B08B 9/027; B08B 5/00

(57) ABSTRACT

New methods and devices for cleaning, drying and sanitizing musical wind instruments are disclosed. According to one embodiment the devices of the invention contain at least the body of the device, inside which are included at least a fan and one or more light emitting sources capable of killing microorganisms. The devices are provided with an internal or external power supply method and are specifically fitted for multiple wind musical instruments either by their shape and design or using various sizes of adaptors to fit multiple musical instruments. The devices are able to dry and sanitize wind instruments in less than 30 minutes of use, before or after playing the instrument.

### CROSS-REFERENCE TO RELATED APPLICATION

This application claims the priority benefit of U.S. Patent Application No. 62/795,830 filed Jan. 23, 2019, which is incorporated herein by reference in its entirety.

### FIELD OF THE INVENTION

The present invention relates generally to methods and devices specifically fitted for cleaning, sanitizing and drying a variety of musical wind instruments, including at least a fan and a light emitting source with a wavelength capable of killing microorganisms.

### BACKGROUND OF THE INVENTION

Wind musical instruments such as trumpets, clarinets, saxophones and the likes need to be cleaned after each use. It has been found that bacteria such as Bacillus Pumilus, Paracoccus yeei, Roseomonas mucosa, Actinmyces naeslundii and arthrobacter aurescens are present in unused wind musical instruments and can be present for days and weeks. Playing for as little as 10 minutes or less deposits bacteria inside the wind musical instrument along with heat and humidity which promotes growth of the newly deposited and any already present bacteria in the instrument. Devices to dry instruments after use include brushes and tissues. Their efficiency in removing moisture is limited and these methods have no direct effect on microorganisms.

Another method of drying wind instruments called the Horn Blower, commercialized by the company Hollywoodwinds Inc. http://hollywoodwinds.com/styled-2/styled-9/ is made of a fan introduced in the horn of the saxophone clarinet or trumpet. Their efficiency in removing moisture is expected to be superior to brushes and tissues but this method has no direct effect on microorganisms.

Wind musical instruments such as trumpets, clarinets, saxophones and the likes have been shown to contain bacteria and molds which may survive for extended periods of time and be deleterious to musician health. (See, Marshall B, Levy S: Microbial contamination of musical wind instruments. Int. J. Environmental Health 2011; 21: 275-285; Mangura B T, Napolitano E C, Passannante M, McDonald R J, Reichman L B: Mycobacterium tuberculosis miniepidemic in a church gospel choir. Chest 1998; 113: 234-7; Cobcroft R, Kronenberg H, Wilkinson T: Cryptococcus in bagpipes. Lancet 1978; June 24; 1 (8078) 1368-9; and Millard F, Bemiller L: Musicians' maladies. N Engl J Med 1989; 321: 52.

Ultraviolet light emitting sources combined with ozone have been reported to be useful to kill bacteria and molds in wind musical instruments by Silversteinworks inc. (REF 6). The bacterial killing efficiency of such light emitting devices not only requires a specific wavelength but also a sufficient light intensity and time of exposure based on exposure conditions.

Despite the recent advances made in cleaning devices for musical wind instruments such as the Horn Blower or the sanitizer by Silversteinworks Inc. https://www.silversteinworks.com/sanitizer/ there remains a need for more adapted and more efficient wind instrument cleaning, drying and sanitizing devices with particular emphasis on the mouthpieces of those devices.

### SUMMARY OF THE INVENTION

The present invention relates generally to methods and devices specifically adapted for cleaning, sanitizing and drying a variety of wind instruments such as trumpets, clarinets, saxophones and the likes, including at least a fan and a light emitting source with a wavelength capable of killing microorganisms.

The present invention is particularly useful where the light emitting source capable of killing bacteria and molds is introduced inside the wind instrument under appropriate conditions of location, position, distance and duration of exposure.

The present invention is particularly useful where the light emitting source is mounted in or on a device containing a fan able to blow air inside the musical wind instruments in conditions allowing rapid drying of the wind instruments in less than 30 minutes. According to a preferred aspect of using the device, air is pulled from the inside of the wind musical instrument to the outside through the mouthpiece. In this manner, drying occurs faster and more efficiently than when air is pushed into the musical instrument through the mouthpiece. Thus, it is preferred that air be pulled into the instrument using the TOPSIDE device or pushed from the horn using a STAND device. In both cases this results in driving the air outside of the instrument through the mouthpiece. Nevertheless, the device may be used in either manner.

It is generally known that bacteria tend to accumulate at the top of wind musical instruments near their mouthpieces where the player blows into the instrument. Bacteria can be detected after playing down to the low end of the barrel of a saxophone and are even lower in the body of instruments such as a clarinet where bacteria is found in approximately in the middle of the instrument.

Different light sources can be used in the devices but LEDs are particularly preferred as they use relatively little power and then not to generate very much heat. The utility of the germicidal light is related to the duration of exposure and distance form bacterial deposits and the duration and power level may be determined by one of skill in the art. According to a preferred aspect of the invention the LEDs emit germicidal light such as in the UV C band of light which has a wavelength of from 260 to 280 nm with a wavelength of 275 nm being preferred. Multiple light sources can be used in practice of the invention including those disposed at opposing ends of the device. Thus, when the device is placed in the middle of a wind musical instrument such as between the barrel and mouthpiece of a saxophone, light sources at each end of the device project not only sanitize the air passing through the device but project down opposite lengths of the instrument in order to sanitize the inner surfaces of the wind musical instrument. According to one aspect of the invention the device can be used for about 10 minutes with the LED energized at from 1-15 mW although shorter or longer times can be selected with greater or lesser light energies.

Various fans can be used according to the invention with 3 cm micro fans with an air flow of at least 1 cubic feet per minute (CFM) with about 5 CFM being particularly useful. Stronger fans can be used but fans stronger than those producing 10 CFM are not necessarily preferred. In general, however, it is preferred that the fan power and light energy be selected such that a drying and sanitizing cycle be less than 30 minutes with a cycle of about 10 minutes being particularly preferred.

The present invention is particularly useful where the device including the light emitting source and the fan has a shape that fits multiple wind instruments or for which adaptors specifically sized for one or more musical instruments can by mounted or added to the device.

According to one aspect of the present invention the device is adapted to the cleaning, drying and sanitizing of the mouthpiece of the wind instruments and according to another aspect the device is adapted to the cleaning, drying and sanitizing of the barrel of the wind instruments. By “sanitizing” is intended a reduction of bacterial count on parts including the mouthpiece of the wind musical instrument of at least one log of base 10 but more preferably 2 logs or 3 or 4 logs. According to a further aspect of the invention the device is adapted to cleaning, drying and sanitizing of wind instruments as a stand which supports the instrument such as a clarinet.

Still further aspects of the invention include additional features such as batteries or power cords for an external power supply, automatic switch or a timer or external electronics and battery included in a connected control box, and wherein the device is designed such to create a Venturi effect to accelerate the air flow out of the device.

### BRIEF DESCRIPTION OF THE DRAWINGS

FIGS. 1A and 1B depict temperature and humidity recordings inside a saxophone during and after play with use of a fan;

FIG. 2 depicts temperature and humidity recordings inside a saxophone during and after play without use of a fan;

FIG. 3 depicts a schematic external view of a “TOPSIDE” device adapted for the mouthpiece or barrel of wind instruments;

FIG. 4 depicts a schematic internal view of a “TOPSIDE” device adapted for mouthpiece or barrel of wind instruments;

FIG. 5 depicts examples of uses of a “TOPSIDE” device with a saxophone;

FIG. 6 depicts a schematic external view of a “STAND” device for wind instruments;

FIG. 7 depicts an example of use of a “STAND” device, e.g. with a clarinet;

FIG. 8 depicts a schematic internal view of a “STAND” device for wind instruments;

FIG. 9 depicts an exploded view of design elements of a “TOPSIDE” device;

FIGS. 10A and 10B depict the mounting of an LED on a thin aluminum stand at each end of a “TOPSIDE” device (A) compared with a commercially available LED with its accompanying cooling plate which is not desired for use because it obstructs air flow;

FIGS. 11A and 11B depict various adaptors useful for mounting a saxophone mouthpiece and fitted with a rubber ring to secure its position into a mouthpiece;

FIG. 12 depicts alternative designs of a “STAND” device; and

FIG. 13 depicts the design elements of a “STAND” device in an exploded view.

### DETAILED DESCRIPTION OF THE INVENTION

The present invention relates generally to methods and devices specifically fitted for cleaning, sanitizing and drying a variety of wind instruments such as trumpets, clarinets, saxophones and the likes, including at least a fan and a light emitting source with a wavelength capable of killing microorganisms.

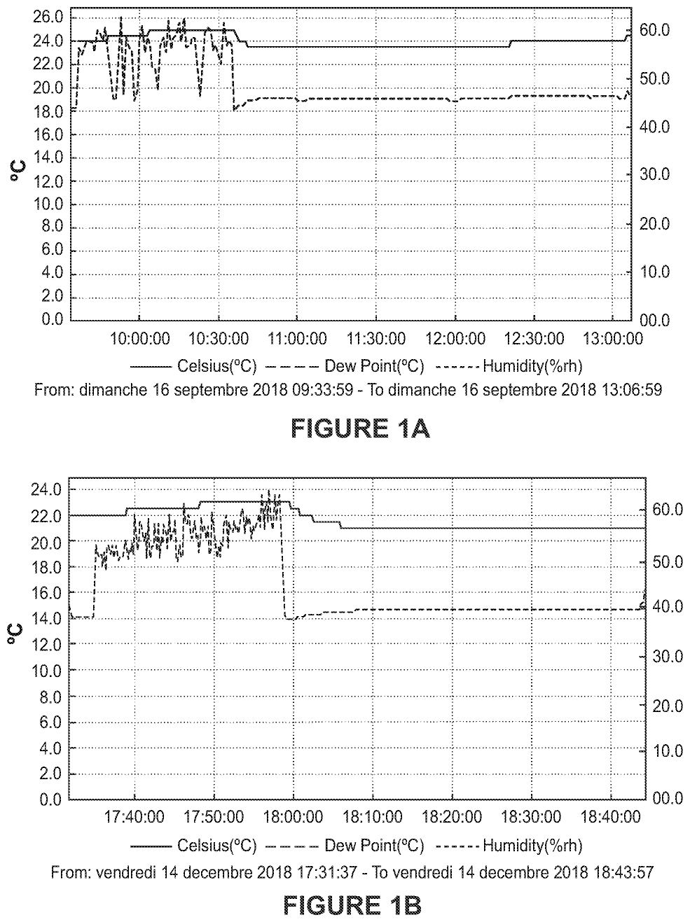

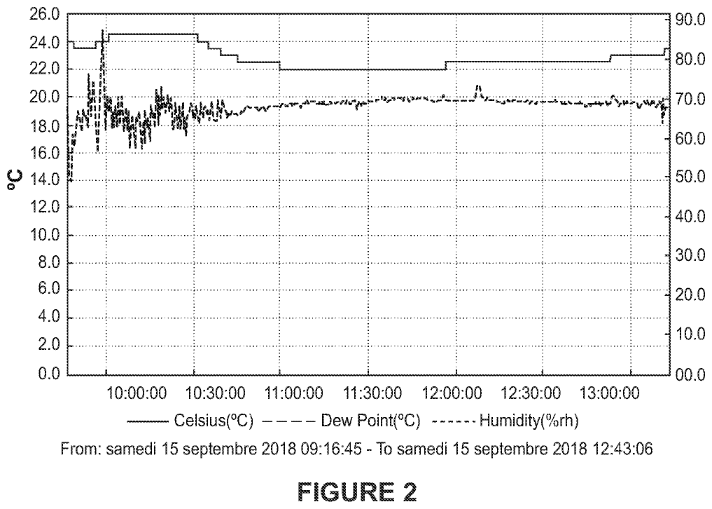

In a first experiment, a fan was introduced in a saxophone after playing music and recordings of temperature and humidity levels were made at regular intervals with or without blowing air into the saxophone. The results using a TOPSIDE device show a rapid decrease in the humidity level from 40-45% prior to play to 60% during play to 45% in the barrel of the saxophone in which air was blown with the fan (see FIGS. 1A and 1B., the fan was started shortly after 10:30 am) whereas humidity stayed high around 70% for at least 2.5 hours in the saxophone in which no air was blown with a fan (See FIG. 2.).

In another experiment, musical instruments were tested for the presence of microorganisms after having been stored for several days without playing them. The reed, the mouthpiece and the mouthpiece cushion were sampled and tested using three types of agar plates: COS (blood agar), MHE (Mueller Hinton agar) and CAN2 (selective agar for molds) with the results shown in Table 1 below.

TABLE 1

| Bacterial strain | COS | MHE | CAN2 |
|---|---|---|---|
| | Reed | | |
| Kocuria rhizophila | | 1 UFC | 0 |
| Staphylococcus sp[1] | 1 UFC | | 0 |
| Unidentified | 2 UFC | 1 UFC | 0 |
| | Mouthpiece | | |
| Bacillus pumilus | numerous UFC | numerous UFC | 0 |
| Paracoccus yeei | numerous UFC | numerous UFC | 0 |
| Roseomonas mucosa | numerous UFC | numerous UFC | 0 |
| Actinomyces naeslundii | numerous UFC | | 0 |
| Arthrobacter aurescens | some UFC | numerous UFC | 0 |
| Unidentified | rare UFC | | 0 |
| | Mouthpiece cushion | | |
| Kocuria rhizophila | many UFC | many UFC | 0 |
| Rothia terrae | many UFC | many UFC | 0 |
| Staphylococcus | many UFC | many UFC | 0 |
| saprophyticus | | | |

Legend:
UFC (French) = CFU (english) = colony forming units

In another experiment, light emitting sources were tested on bacteria and mold cultures for their ability to prevent bacteria and mold growth in vitro: the light emitting sources tested were a LED Tab, a LED Circuit and a UV lamp. The tests were made with 10 minutes of light exposure from 10 cm above the agar plates inoculated with known bacterial solutions.

The results shown in Table 2 below indicate that 1) bacteria were growing in the positive controls without light exposure, 2) bacteria did not grow or were markedly inhibited when the agar plates were exposed to the three light emitting sources tested.

TABLE 2

| | | Number of colonies (UFC) | | | | |
|---|---|---|---|---|---|---|
| | Inoculum | Positive | Led | Led | UV | Negative |
| | (100 μL) | control | Tab | Circuit | lamp | control |
| Staphylococcus epidermidis | ~1000 UFC/mL | 27 | 0 | | 0 | 0 |
| ATCC12228 | ~1000000 UFC/mL | >1000 | 0 | 2 | 0 | |
| Escherichia coli | ~1000 UFC/mL | 235 | 0 | 3 (sides) | 0 | 0 |
| ATCC 25922 | ~1000000 UFC/mL | >1000 | 70 (sides) | | 0 | |
| Streptococcus groupe | ~1000 UFC/mL | 58 | 0 | | 0 | 0 |
| mitis/oralis | ~1000000 UFC/mL | >1000 | 0 | 0 | 3 (in depth) | |

Legend:
UFC (French) = CFU (English) = colony forming units

In another experiment, light emitting sources were mounted on or in a device containing at least a fan and measurements of humidity, temperature and bacteriological survival tests were performed before and after playing music with the wind instrument. The presence of microorganisms in the instrument was tested by multiple sampling and transfer on in vitro agar plates.

It is to be understood that the terminology used herein is for the purpose of describing particular embodiments only and is not intended to limit the scope of the present invention. As used herein and in the claims, the singular forms “a,” “and” and “the” include plural referents unless the context clearly dictates otherwise.

### Example 1

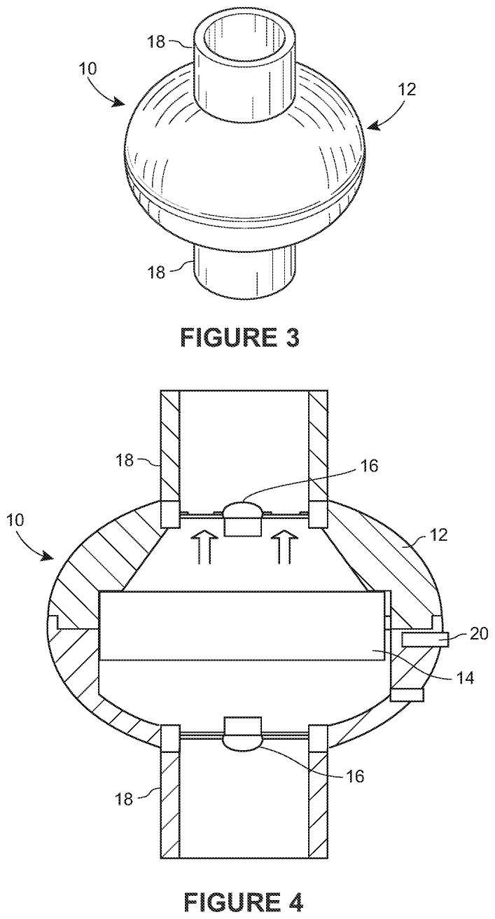

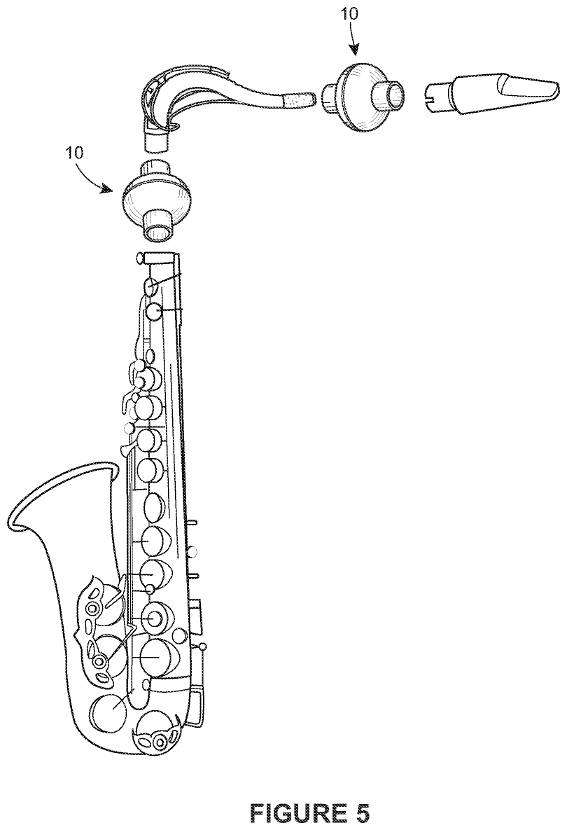

The first example is a device referred to as a *TOPSIDE” device which can be applied to the mouthpiece or to the barrel of the instrument (e.g. a clarinet, a saxophone or the likes). A schematic external view of such a device (10) is shown in FIG. 3. A schematic internal view of the device is shown in FIG. 4. The device (10) contains a main body (12) of a size sufficient to contain the fan (14) and the light emitting source (16) and to which adaptors of various diameters (18) can be added to fit multiple musical wind instruments. The device is also provided with a switch (20) for turning the device on and off and can also contain additional electronics such as timers (not shown). Inside the device are at least a fan (14) which will blow air is one direction and one or more light emitting sources (16). Two light emitting sources (16) are shown in opposite directions in the example given on FIG. 4 but similar devices with only one light emitting source or more than two light emitting sources may be as useful. Likewise the body of the device is shown as a round shape but may be useful also as a square or any other external shape allowing fitting in the fan and the light emitting sources inside. TOPSIDE devices may be used as shown in FIG. 5 between the mouthpiece and the barrel or between the barrel and the body of the instrument (in this case a saxophone) as shown.

The device is reversible and may be used to blow air up or down inside the instrument or the mouthpiece. The body of the device can be designed so as to create a Venturi effect to accelerate the air flow out of the device.

A power supply method is included in the device: a USB connector may be available on the outside of the device for plugging in an external power source, e.g. battery, generator, wall outlet or personal computer. Alternatively, the device may contain a battery or a rechargeable battery pack instead of the USB connector for external power supply.

A switch is available on the outside of the device for turning the device on/off. Optionally the device may also contain an automatic switch and a timer. Optionally the device may also contain an indicator of charging and/or functioning status (e.g. a LED indicating whether the device is charging, charged, on/off, . . . ).

Changeable adaptors of different sizes may be added to the device to fit multiple musical wind instruments.

After the musician has finished playing music, the TOPSIDE device is inserted between the mouthpiece and the barrel, or between the barrel and the body of the instrument, turned on either automatically or via a manual switch, for a duration of time controlled by a timer or via a manual switch. Cleaning and drying of the instrument will be completed in less than 30 minutes. The fan will remove moisture from the instrument and the light emitting source will kill most bacteria and/or molds inside the instrument.

A TOPSIDE device is particularly relevant and efficient in cleaning the mouthpiece and the barrel of the instrument which are the parts receiving the most saliva and exhaled air during musical play and which therefore most require cleaning, drying and sanitizing after each use of the instrument.

### Example 2

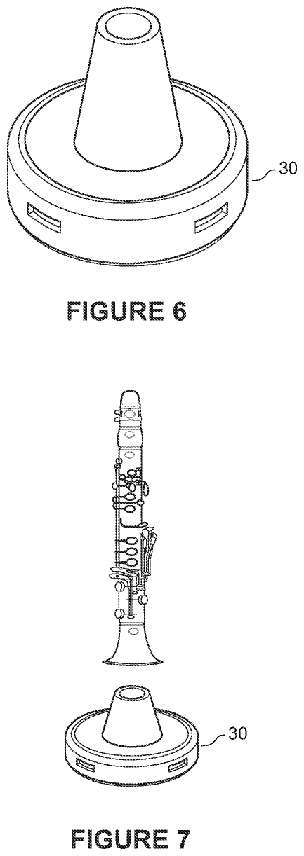

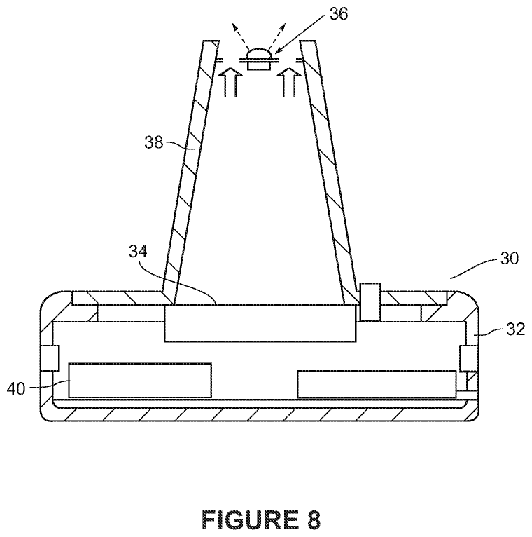

The second example is a device referred to as a *STAND” device which can be used for multiple straight wind instruments (e.g. a clarinet, a flute or the likes). A schematic external view of such a device (30) is shown in FIG. 6 and FIG. 7 depicts the “STAND” device as might be used to treat a clarinet. A schematic internal view of the device is shown in FIG. 8. The device (30) contains a main body (32) of a size sufficient to contain the fan (34) and the light emitting source (36) and to which adaptors of various diameters (38) can be added to fit multiple musical wind instruments. Alternatively, the top part of the body of the device may be replaced to fit specific instruments. Inside the device are at least a fan (34) which will blow air in one direction and one or more light emitting sources (36). The body of the device is shown as a round shape at its base but may be useful also as other external shapes allowing fitting the fan and the light emitting sources inside. STAND devices may be used as shown in FIG. 6 with a clarinet.

The body of the device can be designed so as to create a Venturi effect to accelerate the air flow out of the device.

A power supply method (40) is included in the device: a USB connector may be available on the outside of the device for plugging in an external power source, e.g. battery, generator, wall outlet or personal computer. Alternatively, the device may contain a battery or a rechargeable battery pack instead of the USB connector for external power supply.

A switch is available on the outside of the device for turning the device on/off. Optionally the device may also contain an automatic switch and a timer. Optionally the device may also contain an indicator of charging and/or functioning status (e.g. a LED indicating whether the device is charging, charged, on/off, . . . ).

Changeable adaptors of different sizes may be added or mounted onto the device to fit multiple straight musical wind instruments.

After playing music, the musician simply places its instrument on the stand as depicted on FIG. 8 and turns on the device either automatically or via a manual switch, for a duration of time controlled by a timer or via the manual switch. Cleaning and drying of the instrument will be completed in less than 30 minutes. The fan will remove moisture from the instrument and the light emitting source will kill most bacteria and/or molds inside the instrument.

A STAND device is particularly relevant, convenient and efficient in cleaning, drying and sanitizing straight musical wind instrument after each use of the instrument.

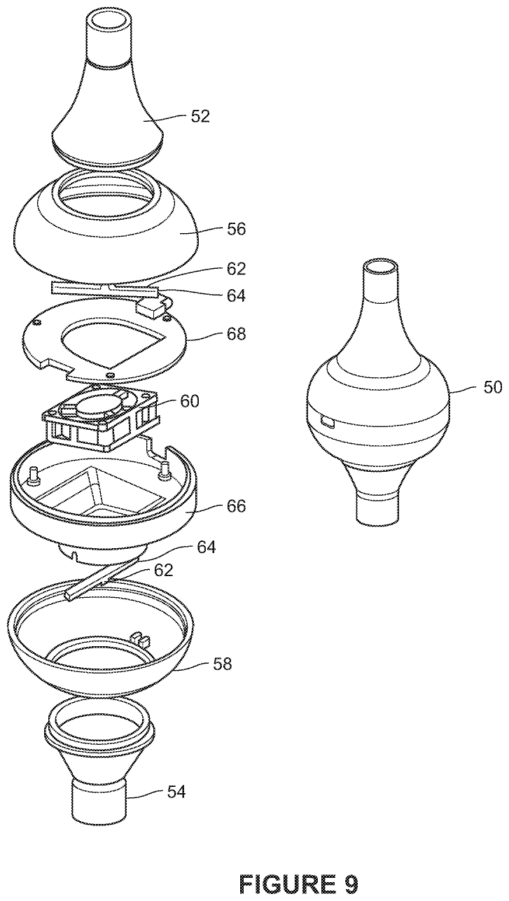

FIG. 9 depicts an exploded view of design elements of a “TOPSIDE” device (50) comprising a first nozzle (52), a second nozzle (54), body parts (56) and (58) disposed adjacent the nozzles; a fan (60), LEDs (62) disposed on aluminum stands (64), an electronics card (68) a support (70) for said electronics card, LEDs and fan.

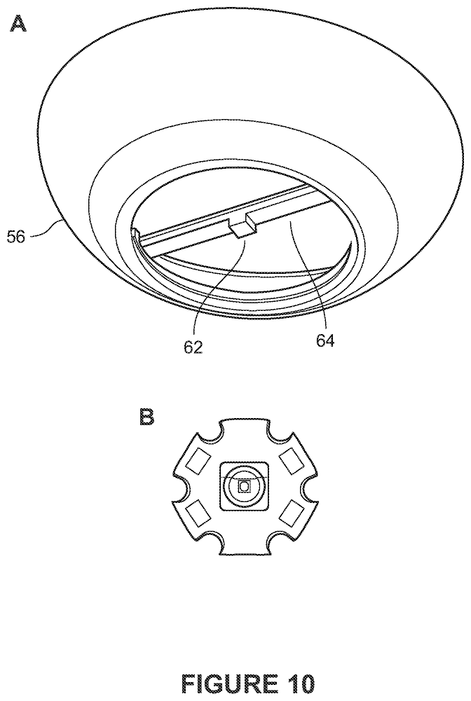

FIGS. 10A and 10B depict the mounting of an LED (62) on a thin aluminum stand (64) at each end of a “TOPSIDE” device (A) compared with a commercially available LED with its accompanying cooling plate which is not desired for use because it obstructs air flow;

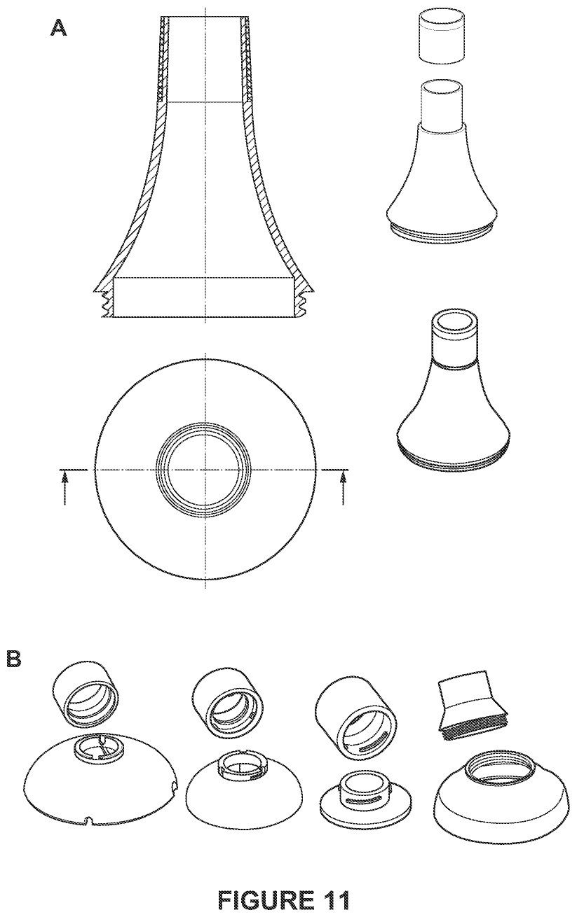

FIGS. 11A and 11B depict various adaptors useful for mounting a saxophone mouthpiece and fitted with a rubber ring to secure its position into a mouthpiece although a variety of other fittings may be used. Further the devices of the invention may be fabricated in a manner such that no adapters are required so as to achieve a secure mounting.

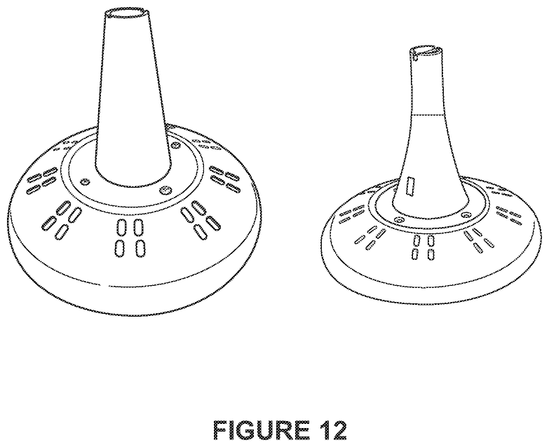

FIG. 12 depicts alternative designs of a “STAND” device for supporting a wind musical instrument.

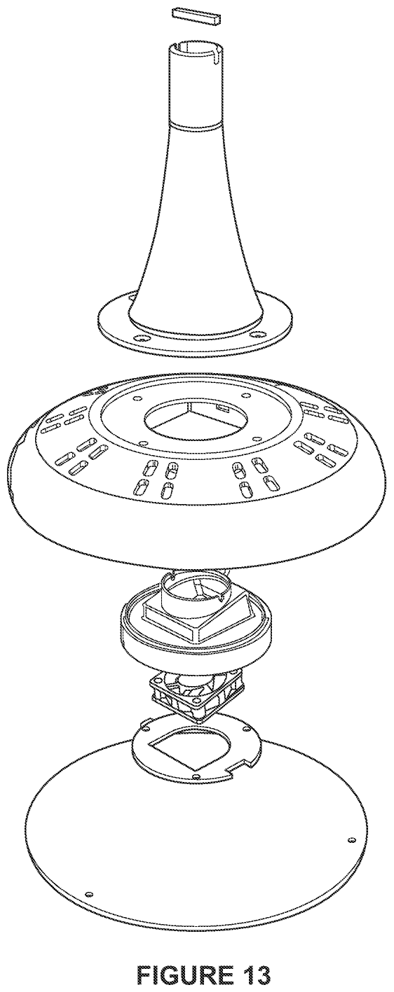

FIG. 13 depicts the design elements of a “STAND” device in an exploded view.

Numerous modifications and variations in the practice of the invention are expected to occur to those skilled in the art upon consideration of the presently preferred embodiments thereof. Consequently, the only limitations which should be placed upon the scope of the invention are those which appear in the appended claims.

What is claimed:

1. A device for drying and sanitizing wind musical instruments comprising a fan and a light emitting source with an internal or external power supply.

2. The device of claim 1 wherein the light emitting source of the device is capable of killing microorganisms or preventing them from growing following light exposure.

3. The device of claim 1 wherein the device comprises a common base comprising said fan and said light emitting source and is adapted to different sizes of wind instruments by its design or by using adaptors of appropriate sizes for these wind instruments.

4. The device of claim 1 wherein the device is adapted to the cleaning and sanitizing of the mouthpiece of the wind instruments.

5. The device of claim 1 wherein the device is adapted to the cleaning and sanitizing of the barrel of the wind instruments.

6. The device of claim 1 which comprises a common base comprising said fan and said light emitting source and is adapted to different sizes of wind instruments by its design or by using adaptors of appropriate sizes for wind instruments.

7. The device of claim 1 wherein the device is adapted to the cleaning and sanitizing of wind instruments as a stand for fully supporting the instrument.

8. The device of claim 1 wherein the device includes an automatic switch or a timer.

9. The device of claim 1 wherein the device is designed such to create a Venturi effect to accelerate the air flow out of the device.

10. A method of drying and sanitizing wind musical instruments comprising mounting a device according to claim 1 onto a the mouthpiece or barrel of a wind musical and forcing air through the body of the wind musical instrument that has been illuminated by the light emitting source.

11. The method of claim 10 where the light emitting source of the device is capable of killing microorganisms or preventing them from growing following light exposure.

12. The method of claim 10 wherein the device comprises a common base comprising said fan and said light emitting source and is adapted to different sizes of wind instruments by its design or by using adaptors of appropriate sizes for these wind instruments.

13. The method of claim 10 wherein the device is adapted to cleaning and sanitizing of the mouthpiece of the wind instruments.

14. The method of claim 12 wherein the device is adapted to cleaning and sanitizing of the barrel of the wind instruments.

15. The method of claim 10 wherein the light emitting source is an LED.

16. The method of claim 10 wherein the LED emits UV C light.

17. The method of claim 10 wherein the LED emits light at a range of from 1 to 15 mW.

18. The method of claim 10 wherein the fan produces an air flow rate of at least 1 cubic feet per minute (CFM).

19. The method of claim 10 wherein air is blown through the wind musical instrument for up to 30 minutes.

20. The method of claim 10 wherein air is blown through the wind musical instrument for less than 10 minutes and the bacterial load of the instrument is reduced by at least one base 10 log.
